(19) United States
(12) Patent Application Publication
(10) Pub. No.: US 2011/0035957 A1
(43) Pub. Date: Feb. 17, 2011

(54) GAS PROCESSING APPARATUS, GAS PROCESSING METHOD, AND STORAGE MEDIUM

(75) Inventors: Yusuke Muraki, Yamanashi (JP); Shigeki Tozawa, Yamanashi (JP)

Correspondence Address: SMITH, GAMBRELL & RUSSELL, 1130 CONNECTICUT AVENUE, N.W., SUITE 1130, WASHINGTON, DC, 20036, US

(73) Assignee: TOKYO ELECTRON LIMITED, Tokyo (JP)

(21) Appl. No.: 12/439,960

(22) PCT Filed: Dec. 20, 2007
(86) PCT No.: PCT/JP2007/074546

§ 371 Date: Nov. 4, 2010

(30) Foreign Application Priority Data
Dec. 26, 2006 (JP) 2006-349479

(51) Int. Cl. F26B 25/00

(52) U.S. Cl. 34/427; 34/236

(57) ABSTRACT

A gas processing apparatus includes a chamber 40 configured to accommodate a wafer W; a transfer mechanism 17 configured to continuously transfer a plurality of wafers W one by one into the chamber 40; a gas supply mechanism configured to supply into the chamber 40 a process gas having a clinging property and prepared for performing a gas process on each of the wafers W; and a control section 90 preset to control the gas supply mechanism and the transfer mechanism to supply the process gas into the chamber before transferring a first target object into the chamber, and then to transfer the first target object into the chamber after the elapse of a predetermined time.

### TECHNICAL FIELD

The present invention relates to a gas processing apparatus and gas processing method for performing a gas process on a target object by use of a process gas having a clinging property, and also to a computer readable storage medium.

### BACKGROUND ART

In recent years, in the process of manufacturing semiconductor devices, a method called “chemical oxide removal (COR) process” has attracted attention as a method alternative to dry etching or wet etching for realizing a fine etching process. As a method of this kind for etching a silicon dioxide (SiO₂) film formed on the surface of a target object, such as a semiconductor wafer, the following COR process is known (for example, see US 2004/0182417 A1, US 2004/0184792 A1, and Jpn. Pat. Appln. KOKAI Publication No. 2005-39185). Specifically, while the temperature of the target object is adjusted under a vacuum state, a mixture gas of hydrogen fluoride (HF) gas and ammonia (NH₃) gas is supplied into a chamber. The mixture gas reacts with the silicon dioxide and generates ammonium fluorosilicate ((NH₄)₂SiF₆). The ammonium fluorosilicate is heated and thereby evaporated in the subsequent step, so that the silicon dioxide film is consumed and etched from the surface.

The COR process is performed by use of a processing system that includes a load/unload section disposed on an atmospheric atmosphere side, a load lock chamber, a heat processing apparatus for heating a semiconductor wafer within an vacuum atmosphere after a COR process, and a COR processing apparatus for performing the COR process on the semiconductor wafer within an vacuum atmosphere, which are linearly arrayed in this order through gate valves. When a process is performed, semiconductor wafers are taken out form a carrier one by one by an atmospheric side transfer unit disposed in the load/unload section and are transferred into the load lock chamber. The load lock chamber is also provided with a transfer unit, by which each semiconductor wafer is transferred through the heat processing apparatus to the COR processing apparatus after the load lock chamber is vacuum-exhausted. Then, the wafer is treated by the COR process in the COR processing apparatus, and is then transferred into the heat processing apparatus and is treated by the heat process. Thereafter, the semiconductor wafer is transferred through the load lock chamber into the a carrier placed in the load/unload section.

In the COR apparatus, the interior of the chamber is purged with N₂ gas in an idling state before the process is started, and is then supplied with HF gas and NH₃ gas when the process is started. HF gas and NH₃ gas are gases that can be easily adsorbed on chamber walls, and so, when HF gas and NH₃ gas are supplied in a state with little gas adsorption due to N₂ gas purge, part of the HF gas and NH₃ gas is adsorbed on chamber walls. For this reason, an effective gas amount supplied onto the surface of the first wafer may be lower and result in ill effects, such as a decrease in etching rate. Thereafter, along with the second and third wafers being processed, the gas amount to be adsorbed and the gas amount to be released to and from chamber walls are balanced, and so the atmosphere is stabilized. For this reason, there is a conventional method for decreasing fluctuations of process characteristics among wafers, which is arranged such that product wafers are processed after one or more dummy wafers are processed in advance to stabilize the atmosphere inside the chamber of the COR processing apparatus

However, where dummy wafers are processed, the effective throughput of a lot process is lowered. Further, the load/unload section needs to include a space for storing dummy wafers and thereby increases the size of the apparatus.

### DISCLOSURE OF INVENTION

An object of the present invention is to provide a gas processing apparatus and gas processing method that can decrease fluctuations of a gas process among target objects without processing dummy objects even where a gas that can be easily adsorbed on a chamber is used.

Another object of the present invention is to provide a computer readable storage medium that stores a control program for executing the method.

According to a first aspect of the present invention, there is provided a gas processing apparatus comprising: a chamber configured to accommodate a target object; a transfer mechanism configured to continuously transfer a plurality of target objects into the chamber; a gas supply mechanism configured to supply a process gas for performing a gas process on each of the target objects into the chamber, the process gas having a clinging property; and a control mechanism preset to control the gas supply mechanism and the transfer mechanism to supply the process gas into the chamber before transferring a starting target object into the chamber, and then to transfer the starting target object into the chamber after elapse of a predetermined time.

In the first aspect, the control mechanism may be preset to transfer the target object into the chamber when an adsorption rate of the process gas onto a wall portion of the chamber inside the chamber falls within a predetermined range. The apparatus may further comprise a pressure measuring mechanism configured to measure a pressure inside the chamber, and the control mechanism may be preset to estimate an adsorption rate of the process gas from a pressure decrease detected by the pressure measuring mechanism and to transfer the target object into the chamber when the adsorption rate falls within a predetermined range.

According to a second aspect of the present invention, there is provided a gas processing apparatus for performing a gas process while continuously transferring a plurality of target objects, the apparatus comprising: a load lock chamber configured to accommodate each of the target objects and to hold an atmospheric state and a vacuum state; a first transfer mechanism configured to transfer the target object into the load lock chamber under an atmospheric atmosphere; a gas processing section configured to supply a process gas having a clinging property to perform a gas process on the target object under a vacuum atmosphere, and thereby to generate a reaction product on a surface of the target object; a heat processing section configured to perform a heat process on the target object under a vacuum atmosphere after the gas process, and thereby to decompose the reaction product; a second transfer mechanism provided to the load lock chamber and configured to transfer the target object into the gas processing section and the heat processing section; and a control mechanism configured to control respective components, wherein the gas processing section comprises a chamber configured to accommodate the target object, and a gas supply mechanism configured to supply the process gas into the chamber, and wherein the control mechanism is preset to control the gas supply mechanism and the second transfer mechanism to supply the process gas into the chamber before transferring a starting target object into the chamber, and then to transfer the starting target object into the chamber after elapse of a predetermined time.

In the second aspect, the control mechanism may be preset to transfer the target object by the second transfer mechanism into the chamber when an adsorption rate of the process gas onto a wall portion of the chamber inside the chamber falls within a predetermined range. The apparatus may further comprise a pressure measuring mechanism configured to measure a pressure inside the chamber, and the control mechanism may be preset to estimate an adsorption rate of the process gas from a pressure decrease detected by the pressure measuring mechanism and to transfer the target object by the second transfer mechanism into the chamber when the adsorption rate falls within a predetermined range.

The apparatus may be arranged such that the heat processing section is disposed adjacent to the load lock chamber and the gas processing section is disposed adjacent to the heat processing section while the load lock chamber, the heat processing section, and the gas processing section are linearly arrayed. In this case, the control mechanism may be preset to control the first and second transfer mechanisms to transfer the starting target object from the load lock chamber into the gas processing section and then transfer a second target object into the load lock chamber; to transfer the starting target object into the heat processing section and then transfer the second target object into the gas processing section after the gas process on the starting target object is finished; to transfer out the starting target object through the load lock chamber and then transfer a third target object into the load lock chamber after the heat process on the starting target object is finished; to transfer the second target object into the heat processing section and then transfer the third target object into the gas processing section after the gas process on the second target object is finished; and to transfer fourth and subsequent target objects in the same way as in the third target object.

The control mechanism may be preset to apply predetermined waiting manners respectively to the starting target object and the second target such that each of the starting target object and the second target object has the same waiting time inside the load lock chamber as the third and subsequent target objects have. The apparatus may be arranged such that the starting target object is set in wait inside the load lock chamber to have the same waiting time as the third and subsequent target objects have, and the second target object is set in wait before being transferred into the load lock chamber to have the same waiting time inside the load lock chamber as the third and subsequent target objects have.

The apparatus may be arranged such that the target object is an Si substrate having a surface oxide film, the gas processing section is configured to supply HF gas and NH₃ gas to generate ammonium fluorosilicate on a surface of the target object, and the heat processing section is configured to heat and thereby decompose the ammonium fluorosilicate.

According to a third aspect of the present invention, there is provided a gas processing method for performing a gas process on target objects by use of a process gas having a clinging property, the method comprising: supplying the process gas into a chamber for performing a gas process on each of the target objects, before transferring a starting target object into the chamber; and continuously transferring the plurality of target objects into the chamber after elapse of a predetermined time from staring supply of the process gas, and performing the gas process continuously on the target objects by use of the process gas in the chamber.

In the third aspect, the method may be preset to transfer the target object into the chamber when an adsorption rate of the process gas onto a wall portion of the chamber inside the chamber falls within a predetermined range. The method may further comprise detecting a pressure decrease inside the chamber, and may be preset to estimate an adsorption rate of the process gas from the pressure decrease and to transfer the target object into the chamber when the adsorption rate falls within a predetermined range.

According to a fourth aspect of the present invention, there is provided a gas processing method for performing a gas process on target objects by use of a process gas having a clinging property in a gas processing apparatus, which comprises a load lock chamber configured to accommodate each of the target objects and to hold an atmospheric state and a vacuum state, a first transfer mechanism configured to transfer the target object into the load lock chamber under an atmospheric atmosphere, a gas processing section configured to supply a process gas having a clinging property to perform a gas process on the target object under a vacuum atmosphere, and thereby to generate a reaction product on a surface of the target object, a heat processing section configured to perform a heat process on the target object under a vacuum atmosphere after the gas process, and thereby to decompose the reaction product, and a second transfer mechanism provided to the load lock chamber and configured to transfer the target object into the gas processing section and the heat processing section, the method comprising: supplying the process gas into a chamber for performing a gas process on each of the target objects in the processing section, before transferring a starting target object into the chamber; and continuously transferring the plurality of target objects into the chamber after elapse of a predetermined time from staring supply of the process gas, and performing the gas process continuously on the target objects by use of the process gas in the chamber.

In the fourth aspect, the method may be preset to transfer the target object into the chamber when an adsorption rate of the process gas onto a wall portion of the chamber inside the chamber falls within a predetermined range. The method may further comprise detecting a pressure decrease inside the chamber, and may be preset to estimate an adsorption rate of the process gas from the pressure decrease and to transfer the target object into the chamber when the adsorption rate falls within a predetermined range.

The gas processing apparatus may be arranged such that the heat processing section is disposed adjacent to the load lock chamber and the gas processing section is disposed adjacent to the heat processing section while the load lock chamber, the heat processing section, and the gas processing section are linearly arrayed, and the method may be preset to transfer the starting target object from the load lock chamber into the gas processing section and then transfer a second target object into the load lock chamber; to transfer the starting target object into the heat processing section and then transfer the second target object into the gas processing section after the gas process on the starting target object is finished; to transfer out the starting target object through the load lock chamber and then transfer a third target object into the load lock chamber after the heat process on the starting target object is finished; to transfer the second target object into the heat processing section and then transfer the third target object into the gas processing section after the gas process on the second target object is finished; and to transfer fourth and subsequent target objects in the same way as in the third target object.

The method may be preset to apply predetermined waiting manners respectively to the starting target object and the second target such that each of the starting target object and the second target object has the same waiting time inside the load lock chamber as the third and subsequent target objects have. In this case, the method may be arranged such that the starting target object is set in wait inside the load lock chamber to have the same waiting time as the third and subsequent target objects have, and the second target object is set in wait before being transferred into the load lock chamber to have the same waiting time inside the load lock chamber as the third and subsequent target objects have.

The method may be arranged such that the target object is an Si substrate having a surface oxide film, the gas processing section is configured to supply HF gas and NH₃ gas to generate ammonium fluorosilicate on a surface of the target object, and the heat processing section is configured to heat and thereby decompose the ammonium fluorosilicate.

According to a fifth aspect of the present invention, there is provided a computer readable storage medium that stores a control program for execution on a computer to control a gas processing apparatus wherein, when executed, the control program causes the computer to control the gas processing apparatus to conduct a gas processing method for performing a gas process on target objects by use of a process gas having a clinging property, the method comprising: supplying the process gas into a chamber for performing a gas process on each of the target objects, before transferring a starting target object into the chamber; and continuously transferring the plurality of target objects into the chamber after elapse of a predetermined time from staring supply of the process gas, and performing the gas process continuously on the target objects by use of the process gas in the chamber.

As described above, the present invention is arranged to supply a process gas having a clinging property into a chamber before transferring a starting target object into the chamber, and then to transfer the starting target object into the chamber after the elapse of a predetermined time. Consequently, the process gas is prevented from being insufficiently supplied onto the target object due to adsorption of the process gas on chamber wall portions in the initial stage, and so the gas process can be stably performed without fluctuations.

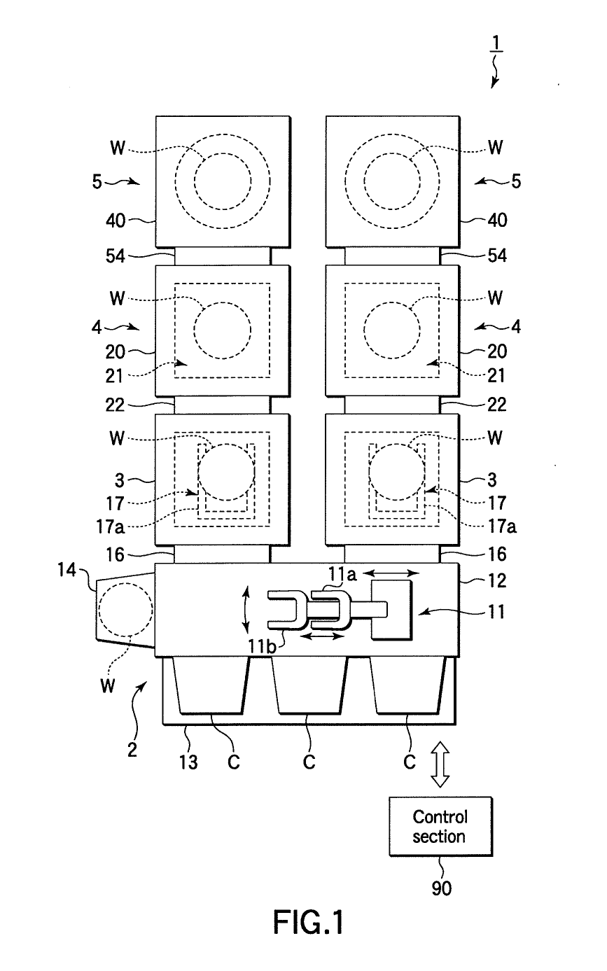

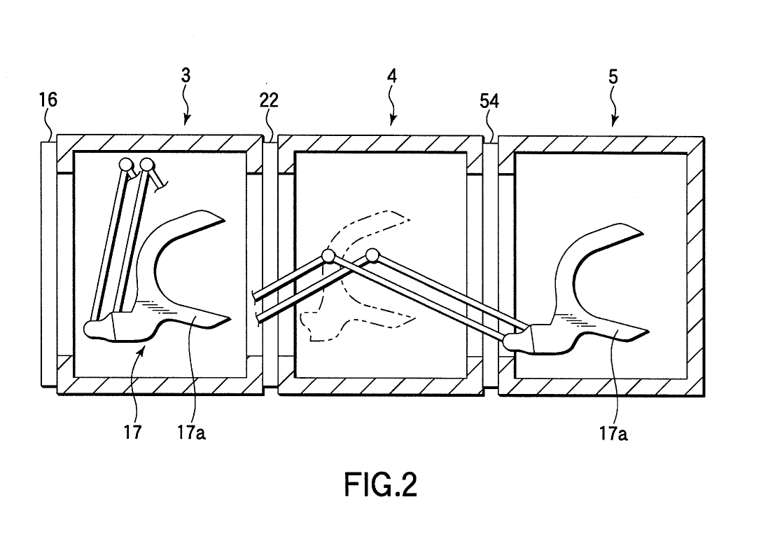

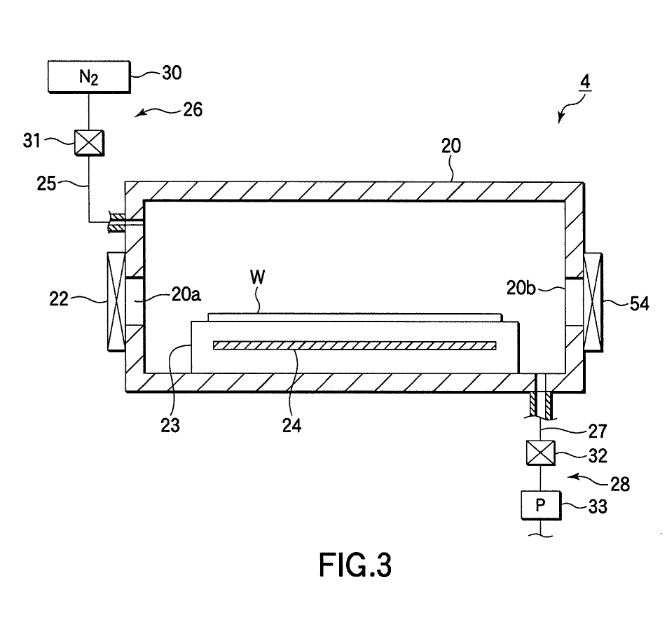

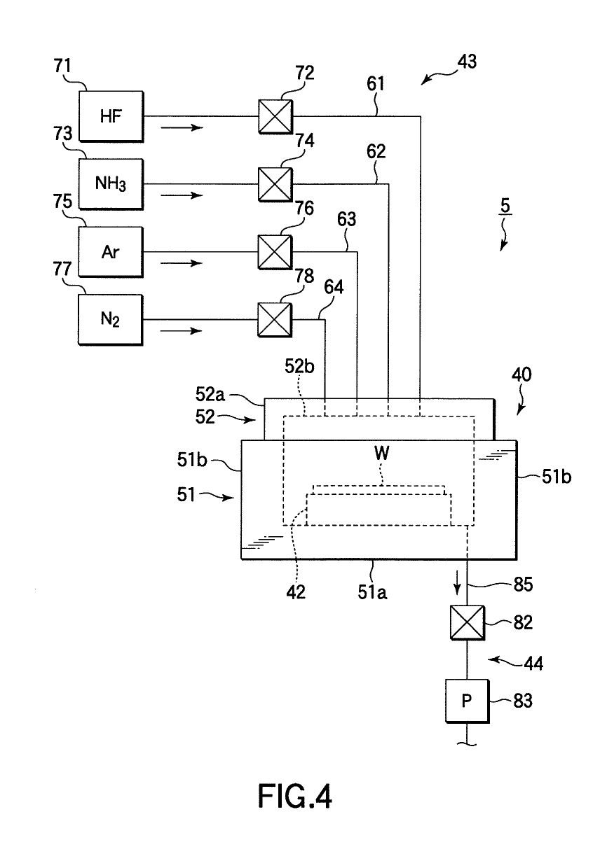

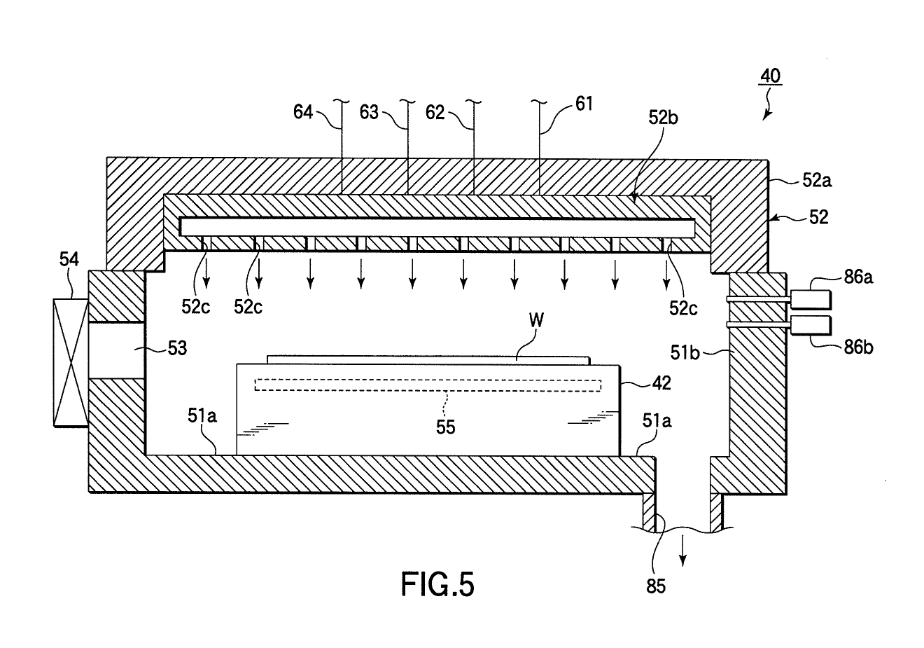

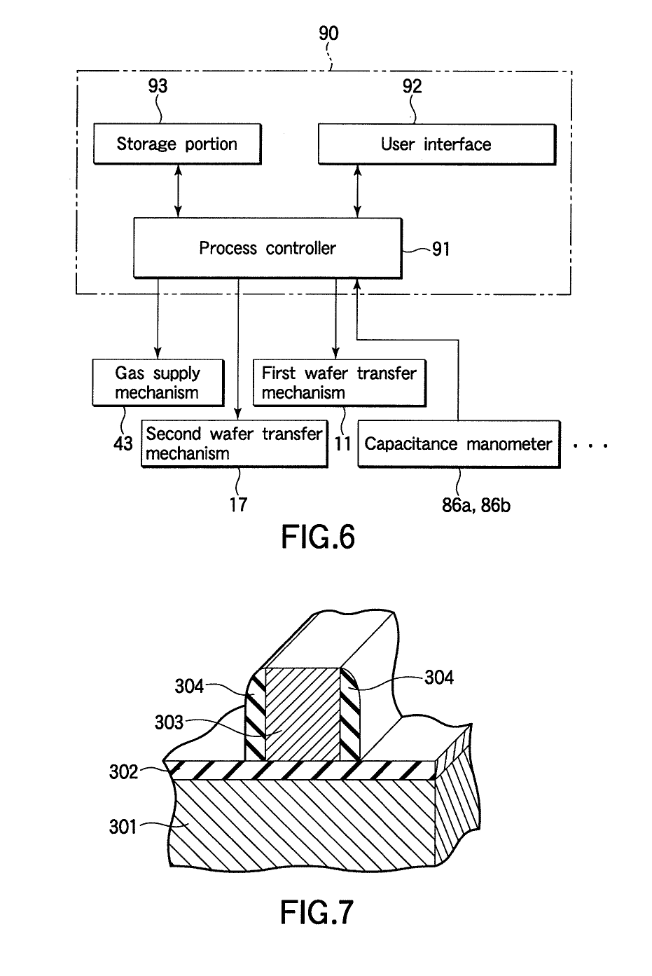

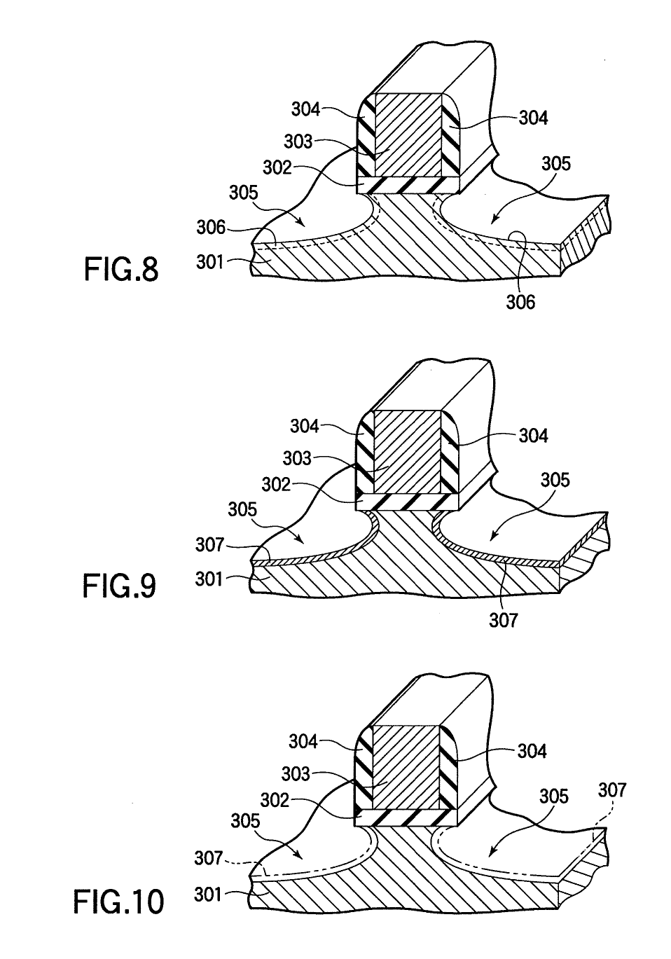

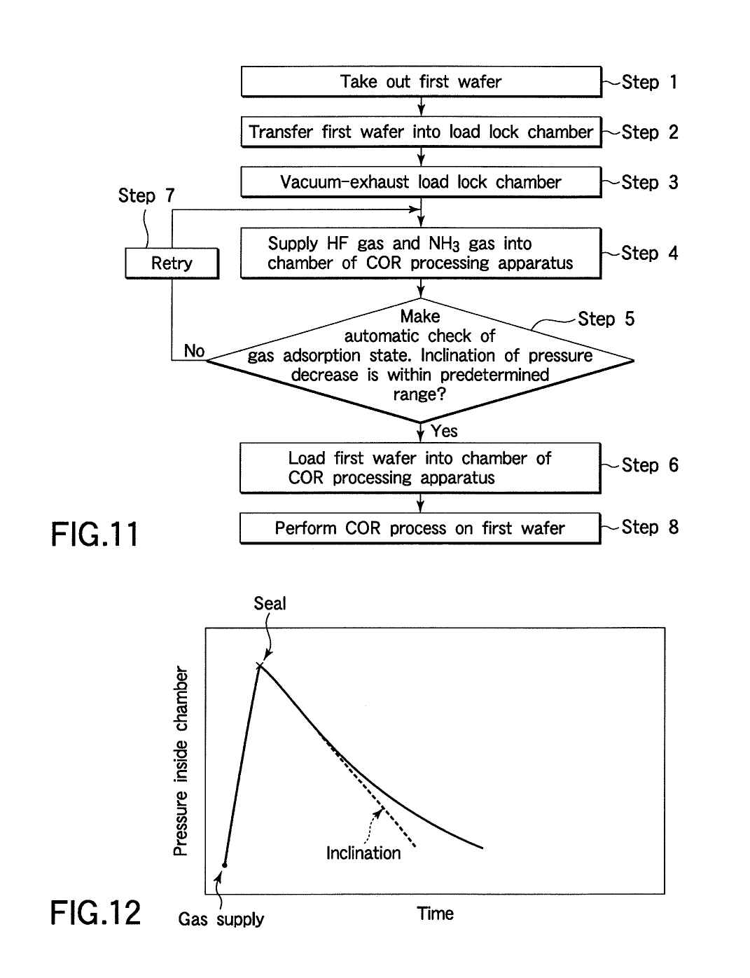

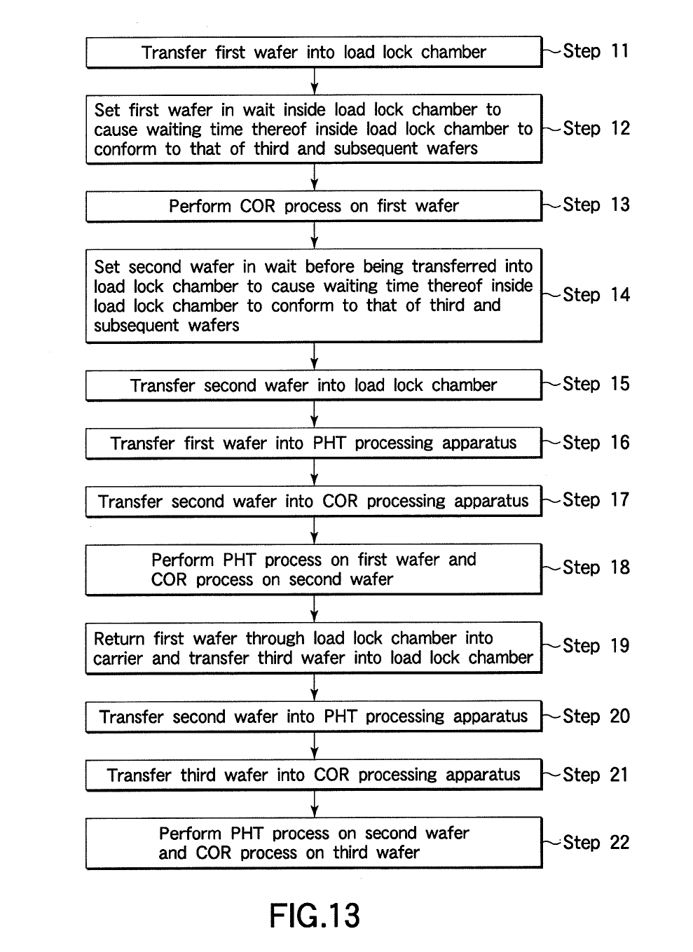

### BRIEF DESCRIPTION OF DRAWINGS

[FIG. 1] This is a plan view schematically showing the structure of a processing system according to an embodiment of the present invention.

[FIG. 2] This is a plan view showing the structure of a second wafer transfer mechanism disposed in the processing system shown in FIG. 1.

[FIG. 3] This is a sectional view showing a PHT processing apparatus disposed in the processing system shown in FIG. 1.

[FIG. 4] This is a side view schematically showing the structure of a COR processing apparatus disposed in the processing system shown in FIG. 1.

[FIG. 5] This is a sectional side view schematically showing the structure of the chamber of the COR processing apparatus disposed in the processing system shown in FIG. 1.

[FIG. 6] This is a block diagram showing the structure of a control section used in the processing system shown in FIG. 1.

[FIG. 7] This is a sectional view showing the structure of a main portion near a wafer surface to be processed in the processing system shown in FIG. 1.

[FIG. 8] This is a sectional view showing the structure of a main portion near the wafer surface obtained after an etching process is performed on the wafer shown in FIG. 7.

[FIG. 9] This is a sectional view showing the structure of a main portion near the wafer surface obtained after a COR process is performed on the wafer shown in FIG. 8.

[FIG. 10] This is a sectional view showing the structure of a main portion near the wafer surface obtained after a PHT process is performed on the wafer shown in FIG. 8.

[FIG. 11] This is a flow chart showing a process sequence of a method according to an embodiment of the present invention performed in the processing system shown in FIG. 1;

[FIG. 12] This is a view for explaining an automatic check of a gas adsorption state inside the chamber of the COR processing apparatus;

[FIG. 13] This is a flow chart showing a process sequence of a method according to an alternative embodiment of the present invention performed in the processing system shown in FIG. 1.

### BEST MODE FOR CARRYING OUT THE INVENTION

Preferable embodiments of the present invention will now be described with reference to the accompanying drawings.

FIG. 1 schematically shows the structure of a processing system 1 according to an embodiment of the present invention. This processing system 1 includes a load/unload section for loading and unloading semiconductor wafers (which may be simply referred to as “wafer” hereinafter) W to and from the processing system 1. Two load lock chambers (L/L) 3 are disposed adjacent to the load/unload section 2. PHT processing apparatuses (PHT) 4 are respectively disposed adjacent to the load lock chambers 3 and each configured to perform a PHT (Post Heat Treatment) process on a wafer W. COR processing apparatuses (COR) 5 are respectively disposed adjacent to the PHT processing apparatuses 4 and each configured to perform a COR process on a wafer W. The load lock chambers 3, PHT processing apparatuses 4, and COR processing apparatuses 5 are arrayed in two rows in this order.

The load/unload section 2 includes a transfer chamber (L/M) 12 provided with a first wafer transfer mechanism 11 disposed therein to transfer wafers W. The first wafer transfer mechanism 11 includes two transfer arms 11a and 11b each for supporting a wafer W essentially in a horizontal state. A table 13 is disposed along the longitudinal side of the transfer chamber 12 and is provided with, e.g., three carriers C each of which can store a plurality of wafers W in an arrayed state. An orienter 14 is disposed adjacent to the transfer chamber 12 and configured to optically detect misalignment of a wafer W by rotating the wafer W and to perform alignment of the wafer W.

In the load/unload section 2, wafers W are supported by the transfer arms 11a and 11b, and are transferred to predetermined positions by the first wafer transfer mechanism 11 being moved linearly in a horizontal direction and a vertical direction. Further, wafers W are loaded and unloaded to and from the carriers C on the table 13, the orienter 14, and the load lock chambers 3 by the transfer arms 11a and 11b being moved back and forth.

The load lock chambers 3 are connected to the transfer chamber 12 respectively through gate valves 16 interposed therebetween. Each of the load lock chambers 3 is provided with a second wafer transfer mechanism 17 disposed therein to transfer wafers W. Each of the load lock chambers 3 is configured to be vacuum-exhausted to a predetermined vacuum level.

As shown in FIG. 2, the second wafer transfer mechanism 17 has an articulated structure with a transfer arm 17a configured to support a wafer W essentially in a horizontal state. According to the wafer transfer mechanism 17, when the articulated structure is contracted, the transfer arm 17a is positioned inside the load lock chamber 3. When the articulated structure is extended, the transfer arm 17a is positioned inside the PHT processing apparatus 4. When the articulated structure is further extended, the transfer arm 17a is positioned inside the COR processing apparatus 5. Accordingly, when a wafer W is supported on the transfer arm 17a and the articulated structure of the second wafer transfer mechanism 17 is extended and/or contracted, the wafer W is transferred among the load lock chamber 3, PHT processing apparatus 4, and COR processing apparatus 5.

As shown in FIG. 3, each of the PHT processing apparatuses 4 includes a chamber 20 that is configured to be vacuum-exhausted and is provided with a table 23 disposed therein to support a wafer W. A heater 24 is embedded in the table 23 to heat a wafer W treated by the COR process, so as to perform a PHT process for evaporating (subliming) a reaction product generated by the COR process. The chamber 20 has a transfer port 20a on the load lock chamber 3 side to transfer a wafer therethrough between the chamber 20 and load lock chamber 3. The transfer port 20a is configured to be opened and closed by a gate valve 22. The chamber 20 further has a transfer port 20b on the COR processing apparatus 5 side to transfer a wafer therethrough between the chamber 20 and COR processing apparatus 5. The transfer port 20b is configured to be opened and closed by a gate valve 54. The chamber 20 is connected to a gas supply mechanism 26 including a gas supply passage 25 for supplying an inactive gas, such as nitrogen gas (N₂), and an exhaust mechanism 28 including an exhaust passage 27 for exhausting gas from inside the chamber 20. The gas supply passage 25 is connected to a nitrogen gas supply source 30. The gas supply passage 25 is provided with a flow rate regulation valve 31 configured to open and close the passage and to adjust the supply flow rate of nitrogen gas. The exhaust passage 27 of the exhaust mechanism 28 is provided with a switching valve 32 and a vacuum pump 33.

As shown in FIGS. 4 and 5, each of the COR processing apparatuses 5 includes an airtight chamber 40 provided with a table 42 disposed therein to support a wafer W essentially in a horizontal state. The COR processing apparatus 5 includes a gas supply mechanism 43 for supplying HF gas, NH₃ gas, and so forth into the chamber 40, and an exhaust mechanism 44 for exhausting gas from inside the chamber 40. When HF gas and NH₃ gas are supplied into the chamber 40 while the pressure of the chamber 40 is maintained at a predetermined value, these gases come into contact with a wafer W and act on an oxide film (SiO₂) formed on the wafer W, so that ammonium fluorosilicate ((NH₄)₂SiF₆) is generated as a reaction product. The oxide film to be processed may be a natural oxide film formed on the surface of the wafer W or an oxide film used as a component of devices.

The chamber 40 is formed of a chamber main body 51 and a lid 52. The chamber main body 51 includes a bottom portion 51a and an essentially cylindrical sidewall portion 51b. The bottom of the sidewall portion 51b is closed by the bottom portion 51a and the top of the sidewall portion 51b is formed as an opening. The lid 52 is attached to close this top opening. The lid 52 is airtightly attached to the sidewall portion 51b with a seal member (not shown) interposed therebetween to ensure that the interior of the chamber 40 is kept airtight.

As shown in FIG. 5, a transfer port 53 is formed in the sidewall portion 51b to transfer a wafer therethrough to and from the chamber 20 of the PHT processing apparatus 4. The transfer port 53 is configured to be opened and closed by a gate valve 54. Accordingly, the chamber 40 is connected through the gate valve 54 to the chamber 20 of the PHT processing apparatus 4.

The lid 52 includes a lid main body 52a and a showerhead 52b for delivering a process gas. The showerhead 52b is disposed at the bottom of the lid main body 52a, so that the bottom of the showerhead 52b serves as the inner surface (the bottom) of the lid 52. The showerhead 52b forms the ceiling of the chamber 40 above the table 42 to supply various gases from above onto a wafer W placed on the table 42. The showerhead 52b has a plurality of delivery ports 52c distributed all over the bottom thereof for delivering a gas.

The table 42 is essentially circular in the plan view and is fixed on the bottom portion 51a. The table 42 is provided with a temperature adjusting member 55 disposed therein to adjust the temperature of the table 42. For example, the temperature adjusting member 55 comprises a conduit for circulating a temperature adjusting medium (such as water), so that the temperature of the table 42 can be adjusted by heat exchange with the temperature adjusting medium flowing through the conduit, and the temperature of the wafer W placed on the table 42 is thereby controlled.

The gas supply mechanism 43 includes the showerhead 52b, an HF gas supply passage 61 for supplying HF gas into the chamber 40, an NH₃ gas supply passage 62 for supplying NH₃ gas, an Ar gas supply passage 63 for supplying Ar as an inactive gas, and an N₂ gas supply passage 64 for supplying N₂ gas. The HF gas supply passage 61, NH₃ gas supply passage 62, Ar gas supply passage 63, and N₂ gas supply passage 64 are connected to the showerhead 52b, so that HF gas, NH₃ gas, Ar gas, and N₂ gas can be delivered through the showerhead 52b into the chamber 40 and diffused.

The HF gas supply passage 61 is connected to an HF gas supply source 71. The HF gas supply passage 61 is provided with a flow rate regulation valve 72 configured to open and close the passage and to adjust the supply flow rate of HF gas. Similarly, the NH₃ gas supply passage 62 is connected to an NH₃ gas supply source 73. The NH₃ gas supply passage 62 is provided with a flow rate regulation valve 74 configured to open and close the passage and to adjust the supply flow rate of ammonia gas. The Ar gas supply passage 63 is connected to an Ar gas supply source 75. The Ar gas supply passage 63 is provided with a flow rate regulation valve 76 configured to open and close the passage and to adjust the supply flow rate of. Ar gas. The N₂ gas supply passage 64 is connected to an N₂ gas supply source 77. The N₂ gas supply passage 64 is provided with a flow rate regulation valve 78 configured to open and close the passage and to adjust the supply flow rate of nitrogen gas.

The exhaust mechanism 44 includes an exhaust passage 85 provided with a switching valve 82 and a vacuum pump 83 for performing forcible exhaust. One end of the exhaust passage 85 is connected to a hole formed in the bottom portion 51a of the chamber 40.

Two capacitance manometers 86a and 86b are inserted into the chamber 40 through the sidewall of the chamber 40 and used as pressure gauges for measuring the pressure inside the chamber 40. The capacitance manometer 86a is prepared for higher pressure, and the capacitance manometer 86b is prepared for lower pressure.

Some of the components of the COR processing apparatus 5, such as the chamber 40 and table 42, are made of Al. The Al material of the chamber 40 may be bare Al or Al having an inner surface prepared by anodic oxidation (which corresponds to the inner surface of the chamber main body 51 and the bottom surface of the showerhead 52b). On the other hand, since the Al surface of the table 42 is required to have high wear resistance, the surface is preferably prepared by anodic oxidation to form an oxide coating (Al₂O₃), which has high wear resistance.

As shown in FIG. 1, the processing system 1 includes a control section 90. As shown in FIG. 6, the control section 90 includes a process controller 91 comprising a microprocessor (computer) for controlling the respective components of the processing system 1. The process controller 91 is connected to a user interface 92, which includes, e.g., a keyboard and a display, wherein the keyboard is used for an operator to input commands for operating the processing system 1, and the display is used for showing visualized images of the operational status of the processing system 1. The process controller 91 is further connected to a storage portion 93, which stores recipes i.e., control programs and various databases for the process controller 91 to control the processing system 1 so as to perform various processes including, e.g., process gas supply and gas exhaust for the chamber 40 in the COR processing apparatus 5, and for the respective components of the processing system 1 to perform predetermined processes in accordance with process conditions. The recipes are stored in the storage medium of the storage portion 93. The storage medium may be of the stationary type, such as a hard disk, or of the portable type, such as a CD-ROM, DVD, or flash memory. Alternatively, the recipes may be used online while they are transmitted from another apparatus through, e.g., a dedicated line, as needed.

A required recipe is retrieved from the storage portion 93 and executed by the process controller 91 in accordance with an instruction or the like input through the user interface 92. Consequently, the processing system 1 can perform a predetermined process under the control of the process controller 91.

Particularly, this embodiment is arranged to prevent process fluctuations from being caused in the the COR processing apparatus 5 by a decrease in the gas supply amount onto the surface of the first wafer (starting wafer) W due to adsorption of HF gas and NH₃ gas on wall portions of the chamber 40. For this purpose, the gas supply mechanism 43 is controlled by the process controller 91 to supply HF gas and NH₃ gas prior to the loading of the first wafer W, and an automatic check of the atmosphere inside the chamber 40 is performed in accordance with detection values obtained by the capacitance manometers 86a and 86b. Further, the first and second wafer transfer mechanisms 11 and 17 are controlled by the process controller 91 to set the waiting time of each wafer W inside the load lock chamber 3 to be constant.

Next, an explanation will be given of such process operations of the processing system 1.

At first, the structure of a wafer W to be processed by the processing system 1 will be explained with reference to FIGS. 7 and 8.

FIG. 7A is a sectional view showing a main portion near the surface (device formation surface) of a wafer W. The wafer W comprises an Si substrate 301 with a poly-silicon film 303 serving as a gate electrode formed thereon through a gate oxide film 302 made of SiO₂. A TEOS-SiO₂ film 304 serving as a sidewall is formed by use of, e.g., TEOS (tetraethyl orthosilicate) on each of the sidewall portions of the poly-silicon film. The surface (upper surface) of the Si substrate 301 is almost flat and is covered with the gate oxide film 302 laminated on the surface. The gate oxide film 302 is formed of a thermal oxide film. The poly-silicon film 303 serving as a gate electrode has been etched to have a predetermined pattern shape, such that it is formed of a long narrow plate extending in a direction perpendicular to the sheet of FIG. 7 from the near side. The TEOS-SiO₂ films 304 extend respectively along the right and left side surfaces of the poly-silicon film 303. The gate oxide film 302 is exposed at positions where part of the poly-silicon film 303 has been etched and removed and the TEOS-SiO₂ layer 304 is not present.

FIG. 8 shows a state of the wafer W obtained after the exposed part of the gate oxide film 302 in the state shown in FIG. 7 is removed by wet etching. When the wafer W is etched, the exposed part of the gate oxide film 302 and part of the Si substrate 301 present as an underlying layer are removed. Consequently, recessed portions 305 are formed by etching on opposite sides with the poly-silicon film 303 and TEOS-SiO₂ films 304 interposed therebetween. The recessed portions 305 are recessed from the surface level of the gate oxide film 302 into the Si substrate 301, and so the Si substrate 301 is exposed in the recessed portions 305. Since the Si substrate 301 can be easily oxidized, a natural oxide film (SiO₂) 306 is formed on the surface inside the recessed portions 305.

Wafers W having the state shown in FIG. 8 are stored in a carrier C and are transferred to the processing system 1. In the processing system 1, the atmospheric side gate valve 16 of one of the load lock chambers 3 is opened, and a wafer W is transferred by one of the transfer arms 11a and 11b of the first wafer transfer mechanism 11 from the carrier C placed on the load/unload section 2 into this load lock chamber 3. In the load lock chamber 3, the wafer W is transferred from the transfer arm 11a or 11b onto the wafer transfer arm 17a of the second wafer transfer mechanism 17 of the load lock chamber 3.

Then, the atmospheric side gate valve 16 is closed, and the interior of the load lock chambers 3 is vacuum-exhausted. Then, the gate valves 22 and 54 are opened, and the wafer transfer arm 17a is extended into the COR processing apparatus 5 and places the wafer W onto the table 42.

Then, the transfer arm 17a is returned back into the load lock chambers 3, and the gate valve 54 is closed to make the interior of the chamber 40 airtight. Then, NH₃ gas, Ar gas, and N₂ gas are supplied from the gas supply mechanism 43 into the chamber 40. Further, the temperature of the wafer W is adjusted by the temperature adjusting member 55 to a predetermined target value (for example, about 25° C.)

Then, HF gas is supplied from the gas supply mechanism 43 into the chamber 40. When HF gas is supplied into the chamber 40 with NH₃ gas supplied in advance, an atmosphere containing HF gas and NH₃ gas is formed inside the chamber 40, and starts a COR process on the wafer W. Consequently, the natural oxide film 306 present on the surface inside the recessed portions 305 of the wafer W chemically reacts with molecules of the hydrogen fluoride gas and molecules of the ammonia gas, and so it is transformed into a reaction product film 307, as shown in FIG. 9. During the COR process, the interior of the chamber 40 is maintained at a predetermined pressure, such as about 13.3 Pa (0.1 Torr).

As reaction products forming the reaction product film 307, ammonium fluorosilicate ((NH₄)₂SiF₆), water, and so forth are generated. Water thus generated is not diffused from the surface of the wafer W but is confined in the reaction product film 307 and held on the surface of wafer W.

After this process is finished, the gate valves 22 and 54 are opened, and the processed wafer W is transferred by the transfer arm 17a of the second wafer transfer mechanism 17 from the table 42 onto the table 23 inside the chamber 20 of the PHT processing apparatus 4. Then, the transfer arm 17a is returned back into the load lock chamber 3, and the gate valves 22 and 54 are closed. Then, while N₂ gas is supplied into the chamber 20, the wafer W on table 23 is heated by the heater 24. The reaction product film 307 generated by the COR process is evaporated by this heating and removed from the inner surface of the recessed portions 305, and so the surface of the Si substrate is exposed, as shown in FIG. 10.

As described above, where the PHT process is performed after the COR process, the natural oxide film 306 is removed within a dry atmosphere, so that no water marks or the like are generated. Further, the etching is performed by a plasma-less process, and so the process causes little damage. In addition, the etching can be performed with high selectivity relative to the TEOS-SiO₂ film. Since the COR process stops making progress of etching when a predetermined time has elapsed, end point control thereof is unnecessary because no reaction is developed even if over-etching is preset.

After the heat process is finished, the wafer W is transferred by the transfer arm 17a of the second wafer transfer mechanism 17 into the load lock chamber 3. Then, the gate valve 22 is closed, the interior of the load lock chambers 3 is returned to atmospheric pressure, and the wafer W is inserted by the first wafer transfer mechanism 11 into a carrier C placed in the load/unload section 2.

The operations described above are repeated the necessary times corresponding to the number of wafers W stored in a carrier C, so that the processes on the wafers W are finished.

In the series of the processes described above, HF gas and NH₃ gas used in the COR processing apparatus 5 can be easily adsorbed or absorbed on the wall surface of the chamber 40. When HF gas and NH₃ gas are supplied in a state where gas is not so adsorbed on the wall surface immediately after an idling state with N₂ gas purge, the HF gas and NH₃ gas are adsorbed on the wall surface and so the effective amount of gas supplied onto the surface of the wafer W becomes smaller. This problem is more prominent in an Al chamber with a surface prepared by anodic oxidation because HF gas or the like is adsorbed more on an Al chamber prepared by anodic oxidation than on a bare Al chamber.

Accordingly, if the first wafer (starting wafer) W is loaded into the chamber 40 of the COR processing apparatus 5 immediately after HF gas and NH₃ gas are supplied, as conventionally performed, the effective amount of gas supplied onto the surface of the wafer W becomes smaller due to gas adsorption as compared to that supplied onto the subsequent wafers W, and the oxide film removal process is fluctuated among wafers due to a decrease in the etching rate and so forth. Further, if dummy wafers are first processed as described previously, the throughput is lowered and the size of the apparatus is increased.

In light of the problems described above, this embodiment is arranged to improve the sequence to prevent the oxide film removal process from being fluctuated among wafers, without using dummy wafers. Next, an explanation will be given of a sequence according to this embodiment with reference to the flow chart shown in FIG. 11.

At first, when an instruction for starting a process is input by an operator, the first wafer (starting wafer) W is taken out from a carrier C by the first transfer mechanism 11 of the load/unload section 2 (Step 1). Then, the first wafer W is transferred into one of the load lock chambers 3 and placed on the transfer arm 17a of the second wafer transfer mechanism 17 in this load lock chamber 3 (Step 2). Then, this load lock chamber 3 is vacuum-exhausted and set at a state for transferring the wafer W into the COR processing apparatus 5 (Step 3). In this state, according to this embodiment, before the first wafer W is loaded into the COR processing apparatus, HF gas and NH₃ gas are supplied into the chamber 40 (Step 4) in accordance with an instruction transmitted from the process controller 90. For this gas supply, the flow rate, pressure, and time are optimized in accordance with process conditions under the control of the process controller 90.

After the elapse of a predetermined time, an automatic check is made of whether the gas adsorption state of the wall portion of the chamber 40 is an acceptable state (Step 5). In the automatic check, while HF gas and NH₃ gas, which are process gases, are supplied into the chamber 40, the valve on the exhaust passage is closed to form a sealed state and a change in the pressure is checked. As shown in FIG. 12, in a state with gas sealed therein as in this case, the pressure is decreased along with adsorption of the gas. Accordingly, when the inclination of the pressure decrease is within a predetermined range, the relationship between the gas adsorption and release is judged as being normal, and thus the wafer W is loaded into the chamber 40 (Step 6). On the other hand, when the inclination of the pressure decrease is out of a predetermined range, the gas supply is performed again (retried) (Step 7), and then rechecked. These operations are kept repeated until the inclination of the pressure decrease falls within a predetermined range. After Step 6, the process using HF gas and NH₃ gas (COR process) is preformed inside the chamber 40 of the COR processing apparatus 5 (Step 8).

In this way, the sequence up to the process in the COR processing apparatus 5 is finished for the first wafer W, during which the second (second-from-start) wafer W is transferred into the load lock chamber 3. The first wafer W is treated by a heat process in the PHT processing apparatus 4, as described above, and is then transferred through the load lock chamber 3 into a carrier C placed in the load/unload section 2. On the other hand, after the process on the first wafer W is finished in the COR processing apparatus 5, the second wafer W is transferred by the transfer arm 17a into the COR processing apparatus 5 and is treated by the process using HF gas and NH₃ gas. In the same way, after the second wafer is processed, wafers W, such as the third (third-from-start) and the fourth (fourth-from-start) wafers, are sequentially transferred and processed.

As described above, there is a period of adjusting the atmosphere inside the chamber 40 before the first wafer W is loaded into the chamber 40 of the COR processing apparatus 5. Consequently, it is possible to solve such a problem that HF gas and NH₃ gas are adsorbed on wall portions of the chamber 40 and the amount of gas supplied to the wafer W is thereby decreased.

The automatic check of Step 5 allows the gas adsorption state to be judged with high accuracy as to whether it is within an acceptable range. However, if the gas flow rate, pressure, and time used in Step 4 are accurately optimized in accordance with process conditions, the automatic check is not necessarily required. In this case, a wafer W may be loaded into the chamber 40 of the COR processing apparatus 5 and treated by the COR process directly after Step 4 by which the gas atmosphere inside the chamber 40 is allowedly stabilized.

Incidentally, in the processing system 1, the process can be fluctuated in the initial stage, depending on the wafer temperature, as well as the atmosphere inside the COR processing apparatus 5 as described above. Specifically, the processing system is used in general such that the first wafer W is transferred into the load lock chamber 3 and then transferred into the COR processing apparatus 5 immediately after the load lock chamber 3 is changed from an atmospheric state to a vacuum state, and thus essentially no waiting time is applied to the first wafer W inside the load lock chamber 3. On the other hand, the second wafer W is transferred into the load lock chamber 3 and is then set in wait inside the load lock chamber 3 for a long time until the COR process on the first wafer W is finished. Further, each of the third and subsequent wafers W is set in wait for a time determined by the difference between the COR process time and PHT process time for the preceding wafer, and is then transferred into the COR processing apparatus 5. Accordingly, the waiting time of the third and subsequent wafers W inside the load lock chamber 3 is shorter than that of the second wafer W inside the load lock chamber 3.

The load lock chamber 3 is adjacent to the PHT processing apparatus 4 whose chamber wall is heated to a temperature of about 80° C. due to heat from the heater 24, and so a wafer W inside the load lock chamber 3 is thereby heated. In this respect, as described above, the waiting time inside the load lock chamber 3 differs among the first wafer, second wafer, and third and subsequent wafers W, and so the temperature of the wafers W varies and thereby fluctuates the process.

In order to prevent the process from being fluctuated due to initial fluctuations of the wafer temperature, the process is performed in accordance with the sequence shown in FIG. 13. At first, the first wafer W is transferred into the load lock chamber 3 (Step 11). When the load lock chamber 3 is changed from an atmospheric state to a vacuum state, an instruction is transmitted from the process controller 90 to the second wafer transfer mechanism 17 to set the first wafer W in wait for a predetermined time that conforms to the waiting time of the third and subsequent wafers in the steady state. Consequently, the second wafer transfer mechanism 17 with the first wafer W held thereon is set in wait for the predetermined time inside the load lock chamber 3 (Step 12). After the predetermined waiting time, the first wafer W is transferred into the COR processing apparatus and is treated by the COR process using HF gas and NH₃ gas, as described above (Step 13). During this process being performed, the second wafer W is taken out and transferred into the load lock chamber 3. At this time, before the second wafer is transferred into the load lock chamber 3, an instruction for a predetermined waiting time is transmitted from the process controller 90 to the first wafer transfer mechanism 11, so as to adjust the waiting time of the second wafer W inside the load lock chamber 3 to conform to the waiting time of the third and subsequent wafers W. Consequently, the first wafer transfer mechanism 11 with the second wafer W held thereon is set in wait for the predetermined time (Step 14). After the predetermined waiting time, the second wafer W is transferred by the first wafer transfer mechanism 11 into the load lock chamber 3 (Step 15). Then, after the COR process on the first wafer W is finished, the first wafer W is transferred into the PHT processing apparatus 4 (Step 16), and then the second wafer W is transferred into the COR processing apparatus 5 (Step 17). Then, the COR process is performed on the second wafer W in the COR processing apparatus 5 and the PHT process is performed on the first wafer W in the PHT processing apparatus 4 (Step 18). Thereafter, the first wafer W treated by the PHT process in the PHT processing apparatus 4 is transferred into the load lock chamber 3. Then, the first wafer is received from the load lock chamber 3 by one of the transfer arms of the first wafer transfer mechanism 11, and the third wafer W taken out from the carrier C by the other of the transfer arms is transferred into the load lock chamber 3 (Step 19). Then, after the COR process on the second wafer W is finished, the second wafer W is transferred into the PHT processing apparatus 4 (Step 20), and then the third wafer W is transferred into the COR processing apparatus 5 (Step 21). Then, the PHT process is performed on the second wafer W and the COR process is performed on the third wafer W (Step 22). Thereafter, the PHT process sequentially performed on the third wafer. The fourth and subsequent wafers W are transferred and processed in the same way as in the third wafer.

As described above, a suitable waiting time is applied in accordance with an instruction transmitted from the process controller 90, so that the waiting time of each of the first and second wafers W inside the load lock chamber 3 becomes the same as the waiting time of the third and subsequent wafers W inside the load lock chamber 3. Consequently, the process is prevented from being fluctuated due to fluctuations of the wafer temperature.

The present invention is not limited to the embodiment described above, and it may be modified in various manners. For example, in the embodiment described above, the gas process is exemplified by the COR process, but the present invention may be applied to another process that uses a gas to be adsorbed on chamber wall portions. Further, the gas to be adsorbed on chamber wall portions is exemplified by the HF gas and NH₃ gas, but the present invention may be applied to a gas process using another halogen gas, such as a chlorine-containing gas. Further, in the embodiment described above, target objects are continuously transferred one by one, but they may be continuously transferred two by two or more.

### INDUSTRIAL APPLICABILITY

The present invention is effectively applied to a single-substrate gas processing apparatus using a gas that can be easily adsorbed on chamber wall portions.

1. A gas processing apparatus comprising:
a chamber configured to accommodate a target object;
a transfer mechanism configured to continuously transfer a plurality of target objects into the chamber;
a gas supply mechanism configured to supply a process gas for performing a gas process on each of the target objects into the chamber, the process gas having a clinging property; and
a control mechanism preset to control the gas supply mechanism and the transfer mechanism to supply the process gas into the chamber before transferring a starting target object into the chamber, and then to transfer the starting target object into the chamber after elapse of a predetermined time.

2. The gas processing apparatus according to claim 1, wherein the control mechanism is preset to transfer the target object into the chamber when an adsorption rate of the process gas onto a wall portion of the chamber inside the chamber falls within a predetermined range.

3. The gas processing apparatus according to claim 2, wherein the apparatus further comprises a pressure measuring mechanism configured to measure a pressure inside the chamber, and the control mechanism is preset to estimate an adsorption rate of the process gas from a pressure decrease detected by the pressure measuring mechanism and to transfer the target object into the chamber when the adsorption rate falls within a predetermined range.

4. A gas processing apparatus for performing a gas process while continuously transferring a plurality of target objects, the apparatus comprising:
a load lock chamber configured to accommodate each of the target objects and to hold an atmospheric state and a vacuum state;
a first transfer mechanism configured to transfer the target object into the load lock chamber under an atmospheric atmosphere;
a gas processing section configured to supply a process gas having a clinging property to perform a gas process on the target object under a vacuum atmosphere, and thereby to generate a reaction product on a surface of the target object;
a heat processing section configured to perform a heat process on the target object under a vacuum atmosphere after the gas process, and thereby to decompose the reaction product;
a second transfer mechanism provided to the load lock chamber and configured to transfer the target object into the gas processing section and the heat processing section; and
a control mechanism configured to control respective components,
wherein the gas processing section comprises
a chamber configured to accommodate the target object, and
a gas supply mechanism configured to supply the process gas into the chamber, and
wherein the control mechanism is preset to control the gas supply mechanism and the second transfer mechanism to supply the process gas into the chamber before transferring a starting target object into the chamber, and then to transfer the starting target object into the chamber after elapse of a predetermined time.

5. The gas processing apparatus according to claim 4, wherein the control mechanism is preset to transfer the target object by the second transfer mechanism into the chamber when an adsorption rate of the process gas onto a wall portion of the chamber inside the chamber falls within a predetermined range.

6. The gas processing apparatus according to claim 5, wherein the apparatus further comprises a pressure measuring mechanism configured to measure a pressure inside the chamber, and the control mechanism is preset to estimate an adsorption rate of the process gas from a pressure decrease detected by the pressure measuring mechanism and to transfer the target object by the second transfer mechanism into the chamber when the adsorption rate falls within a predetermined range.

7. The gas processing apparatus according to claim 4, wherein the heat processing section is disposed adjacent to the load lock chamber and the gas processing section is disposed adjacent to the heat processing section while the load lock chamber, the heat processing section, and the gas processing section are linearly arrayed.

8. The gas processing apparatus according to claim 7, wherein the control mechanism is preset to control the first and second transfer mechanisms to transfer the starting target object from the load lock chamber into the gas processing section and then transfer a second target object into the load lock chamber; to transfer the starting target object into the heat processing section and then transfer the second target object into the gas processing section after the gas process on the starting target object is finished; to transfer out the starting target object through the load lock chamber and then transfer a third target object into the load lock chamber after the heat process on the starting target object is finished; to transfer the second target object into the heat processing section and then transfer the third target object into the gas processing section after the gas process on the second target object is finished; and to transfer fourth and subsequent target objects in the same way as in the third target object.

9. The gas processing apparatus according to claim 8, wherein the control mechanism is preset to apply predetermined waiting manners respectively to the starting target object and the second target such that each of the starting target object and the second target object has the same waiting time inside the load lock chamber as the third and subsequent target objects have.

10. The gas processing apparatus according to claim 9, wherein the starting target object is set in wait inside the load lock chamber to have the same waiting time as the third and subsequent target objects have, and the second target object is set in wait before being transferred into the load lock chamber to have the same waiting time inside the load lock chamber as the third and subsequent target objects have.

11. The gas processing apparatus according to claim 4, wherein the target object is an Si substrate having a surface oxide film, the gas processing section is configured to supply HF gas and NH₃ gas to generate ammonium fluorosilicate on a surface of the target object, and the heat processing section is configured to heat and thereby decompose the ammonium fluorosilicate.

12. A gas processing method for performing a gas process on target objects by use of a process gas having a clinging property, the method comprising:
supplying the process gas into a chamber for performing a gas process on each of the target objects, before transferring a starting target object into the chamber; and
continuously transferring the plurality of target objects into the chamber after elapse of a predetermined time from staring supply of the process gas, and performing the gas process continuously on the target objects by use of the process gas in the chamber.

13. The gas processing method according to claim 12, wherein the method is preset to transfer the target object into the chamber when an adsorption rate of the process gas onto a wall portion of the chamber inside the chamber falls within a predetermined range.

14. The gas processing method according to claim 13, wherein the method further comprises detecting a pressure decrease inside the chamber, and is preset to estimate an adsorption rate of the process gas from the pressure decrease and to transfer the target object into the chamber when the adsorption rate falls within a predetermined range.

15. A gas processing method for performing a gas process on target objects by use of a process gas having a clinging property in a gas processing apparatus, which comprises a load lock chamber configured to accommodate each of the target objects and to hold an atmospheric state and a vacuum state, a first transfer mechanism configured to transfer the target object into the load lock chamber under an atmospheric atmosphere, a gas processing section configured to supply a process gas having a clinging property to perform a gas process on the target object under a vacuum atmosphere, and thereby to generate a reaction product on a surface of the target object, a heat processing section configured to perform a heat process on the target object under a vacuum atmosphere after the gas process, and thereby to decompose the reaction product, and a second transfer mechanism provided to the load lock chamber and configured to transfer the target object into the gas processing section and the heat processing section,
the method comprising:
supplying the process gas into a chamber for performing a gas process on each of the target objects in the processing section, before transferring a starting target object into the chamber; and
continuously transferring the plurality of target objects into the chamber after elapse of a predetermined time from staring supply of the process gas, and performing the gas process continuously on the target objects by use of the process gas in the chamber.

16. The gas processing method according to claim 15, wherein the method is preset to transfer the target object into the chamber when an adsorption rate of the process gas onto a wall portion of the chamber inside the chamber falls within a predetermined range.

17. The gas processing method according to claim 16, wherein the method further comprises detecting a pressure decrease inside the chamber, and is preset to estimate an adsorption rate of the process gas from the pressure decrease and to transfer the target object into the chamber when the adsorption rate falls within a predetermined range.

18. The gas processing method according to claim 15, wherein the gas processing apparatus is arranged such that the heat processing section is disposed adjacent to the load lock chamber and the gas processing section is disposed adjacent to the heat processing section while the load lock chamber, the heat processing section, and the gas processing section are linearly arrayed, and
the method is preset to transfer the starting target object from the load lock chamber into the gas processing section and then transfer a second target object into the load lock chamber; to transfer the starting target object into the heat processing section and then transfer the second target object into the gas processing section after the gas process on the starting target object is finished; to transfer out the starting target object through the load lock chamber and then transfer a third target object into the load lock chamber after the heat process on the starting target object is finished; to transfer the second target object into the heat processing section and then transfer the third target object into the gas processing section after the gas process on the second target object is finished; and to transfer fourth and subsequent target objects in the same way as in the third target object.

19. The gas processing method according to claim 18, wherein the method is preset to apply predetermined waiting manners respectively to the starting target object and the second target such that each of the starting target object and the second target object has the same waiting time inside the load lock chamber as the third and subsequent target objects have.

20. The gas processing method according to claim 19, wherein the starting target object is set in wait inside the load lock chamber to have the same waiting time as the third and subsequent target objects have, and the second target object is set in wait before being transferred into the load lock chamber to have the same waiting time inside the load lock chamber as the third and subsequent target objects have.

21. The gas processing method according to claim 15, wherein the target object is an Si substrate having a surface oxide film, the gas processing section is configured to supply HF gas and NH₃ gas to generate ammonium fluorosilicate on a surface of the target object, and the heat processing section is configured to heat and thereby decompose the ammonium fluorosilicate.

22. A computer readable storage medium that stores a control program for execution on a computer to control a gas processing apparatus wherein, when executed, the control program causes the computer to control the gas processing apparatus to conduct a gas processing method for performing a gas process on target objects by use of a process gas having a clinging property, the method comprising:
supplying the process gas into a chamber for performing a gas process on each of the target objects, before transferring a starting target object into the chamber; and
continuously transferring the plurality of target objects into the chamber after elapse of a predetermined time from staring supply of the process gas, and performing the gas process continuously on the target objects by use of the process gas in the chamber.
